(19) United States
(12) Patent Application Publication
(10) Pub. No.: US 2025/0089936 A1
(43) Pub. Date: Mar. 20, 2025

(54) DIVERSION ASSEMBLY AND COOKING APPARATUS

(71) Applicants: GUANGDONG MIDEA KITCHEN APPLIANCES MANUFACTURING CO., LTD., FOSHAN (CN); MIDEA GROUP CO., LTD., FOSHAN (CN)

(72) Inventors: Weiwei DING, FOSHAN (CN); Cun LIU, FOSHAN (CN); Zhibin QI, FOSHAN (CN); Yun TIAN, FOSHAN (CN); Peng ZHONG, FOSHAN (CN); Weijie XIAN, FOSHAN (CN); Jingyong FENG, FOSHAN (CN)

(21) Appl. No.: 18/576,746

(22) PCT Filed: Jul. 25, 2022
(86) PCT No.: PCT/CN2022/107609

§ 371 Date: Jan. 5, 2024

(30) Foreign Application Priority Data
Sep. 7, 2021 (CN) 202111044187.1

(51) Int. Cl. A47J 36/38; A47J 27/04

(52) U.S. Cl. CPC A47J 36/38; A47J 2027/043

(57) ABSTRACT

A diversion assembly and a cooking apparatus having said diversion assembly. An embodiment includes a support plate and a first diversion groove, the first diversion groove is arranged on the support plate or is a part of a structure of the support plate, and the first diversion groove includes a bottom plate portion and side plate portions arranged at two sides of the bottom plate portion; the bottom plate portion is an integrated structure, and the bottom plate portion includes a lateral diversion portion and a longitudinal diversion portion; the lateral diversion portion is arranged at an incline towards a lower plate surface of the support plate along the length direction of the support plate; the longitudinal diversion portion is arranged at an incline toward the lower plate surface of the support plate along the width direction of the support plate.

### CROSS-REFERENCES TO RELATED APPLICATIONS

The present disclosure is a national phase application of International Application No. PCT/CN2022/107609, filed on Jul. 25, 2022, which claims priority and benefits to Chinese patent application No. 202111044187.1 filed with CHINA NATIONAL INTELLECTUAL PROPERTY ADMINISTRATION on Sep. 7, 2021, the entireties of which are herein incorporated by reference

### FIELD

The present disclosure belongs to the field of cooking apparatuses, and specifically relates to a flow guide assembly and a cooking apparatus having the flow guide assembly.

### BACKGROUND

With the continuous improvement of people's quality of life, kitchen appliances are becoming increasingly abundant, and cooking apparatuses such as microwaves, ovens and steamers are gradually becoming essential kitchen appliances in family life. At present, there is a common problem with cooking apparatuses on the market, especially those with a steam heating function, that is, condensed water will be generated in a cavity after completion of cooking. If users do not clean the accumulated water in a timely manner, a heating speed will be slow when the heating function is used for the next time. This is because the condensed water in the cavity will absorb some heat, and the long-term residual condensed water will produce a peculiar smell, which will affect the user experience.

In the existing microwave ovens, water vapor in the cavity of the microwave oven leaks from riveting gaps at a bottom of the back of the cavity to the outside of the cavity, and drips onto a water flow track; then the water is guided to a water collection box through multiple spliced water flow tracks. The water flow tracks of the microwave oven are of a segmented spliced structure, with gaps or poor splicing at the splicing points, which can lead to water seepage or leakage to a lower part of the oven body, thus easily causing moisture in an electrical room, rusting of sheet metal parts, and problems such as open circuit in severe cases.

### SUMMARY

An object of the present disclosure is to at least solve the problem of water leakage in the water flow tracks, and this object is achieved through the following embodiments.

One embodiment of the present disclosure proposes a flow guide assembly, which includes:
a support plate;
a first flow guide groove arranged on the support plate or being part of the structure of the support plate, in which the first flow guide groove includes a bottom plate portion and side plate portions arranged on both sides of the bottom plate portion; the bottom plate portion is of an integrated structure, and includes a transverse flow guide portion and a longitudinal flow guide portion; the transverse flow guide portion is arranged inclinedly toward a lower plate face of the support plate in a length direction of the support plate, the longitudinal flow guide portion is arranged inclinedly toward the lower plate face of the support plate in a width direction of the support plate, and a highest point of the longitudinal flow guide portion is set lower than or equal to a lowest point of the transverse flow guide portion.

According to the flow guide assembly of the present disclosure, the support plate is arranged below the cavity of the cooking apparatus, and the first flow guide groove is arranged opposite to a water flow hole of the cavity. The condensed water formed inside the cavity is discharged to the outside of the cavity through the water flow hole and falls into the first flow guide groove. The first flow guide groove in the present disclosure is provided with a transverse flow guide portion and a longitudinal flow guide portion, the transverse flow guide portion is arranged inclinedly toward the lower plate face of the support plate in the length direction of the support plate, the longitudinal flow guide portion is arranged inclinedly toward the lower plate face of the support plate in the width direction of the support plate, and the highest point of the longitudinal flow guide portion is set lower than or equal to the lowest point of the transverse flow guide portion; therefore, an effective flow guide effect can be realized, and the condensed water can be guided into a wastewater box of the cooking apparatus. Due to the integrated structure of the bottom plate portion of the first flow guide groove in the present disclosure, there are no gaps on the plate face of the bottom plate portion, so there will be no leakage of condensed water on the surface of the bottom plate portion, thus ensuring the normal discharge of condensed water, preventing the condensed water from staying on the support plate, reducing damage to other electrical components or sheet metal parts, and improving the safety and reliability of the use of the cooking apparatus.

In addition, the flow guide assembly according to the present disclosure may also have the following additional features.

In some embodiments of the present disclosure, the bottom plate portion and the side plate portions on both sides are of an integrated structure.

In some embodiments of the present disclosure, the first flow guide groove is a groove formed by a top face of the support plate being recessed toward a bottom face of the support plate.

In some embodiments of the present disclosure, the first flow guide groove is arranged along an outer edge of the support plate.

In some embodiments of the present disclosure, the transverse flow guide portion and the longitudinal flow guide portion are respectively arranged on two adjacent side edges of the support plate.

In some embodiments of the present disclosure, the support plate is further provided with a drain hole, which is located at an extremity end in an extending direction of the first flow guide groove and penetrates through the support plate.

In some embodiments of the present disclosure, the flow guide assembly further includes a transition portion which is located below the support plate, and the transition portion is provided with a second flow guide groove which is communicated with the drain hole.

In some embodiments of the present disclosure, the transition portion and the support plate are of an integrated structure or a detachable structure.

Another embodiment of the present disclosure also proposes a cooking apparatus, which has the flow guide assembly as described in any of the above; the cooking apparatus further includes a cavity with a cooking chamber, and the flow guide assembly is arranged below the cavity; a water flow hole is arranged at the bottom of the cavity, and the first flow guide groove is arranged opposite to the water flow hole.

In some embodiments of the present disclosure, the bottom plate portion is arranged inclinedly toward a bottom face of the support plate in a direction from a back plate to a front plate of the cavity.

### BRIEF DESCRIPTION OF THE DRAWINGS

Upon reading the detailed description of the embodiments below, various other embodiments will become clear. The accompanying drawings are only used for the purpose of illustrating embodiments, and should not be considered as a limitation to the present disclosure. Moreover, throughout the drawings, the same reference signs are used to denote the same components, in which:

FIG. 1 is a schematic exploded structural view of a cooking apparatus according to this embodiment;

FIG. 2 is a schematic exploded structural view of the cooking apparatus in FIG. 1 from another perspective;

FIG. 3 is a schematic structural view of a support plate in FIG. 2; and

FIG. 4 is a schematic view of a connection structure between the support plate in FIG. 2 and a transition portion.

### LIST OF REFERENCE SIGNS

1: cooking apparatus;
10: cavity; 11: cooking chamber; 12: rear plate; 13: front plate; 14: bottom plate;
20: flow guide assembly; 21: support plate; 211: support portion; 212: first flow guide groove; 2121: transverse flow guide portion; 2122: longitudinal flow guide portion; 213: first flange portion; 214: second flange portion; 215: drain hole; 22: transition portion; 221: second flow guide groove.

### DETAILED DESCRIPTION OF THE DISCLOSURE

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the cited features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “on”, “above”, etc. These spatial relative terms are intended to include different orientations of the device in use or in operation in addition to the orientation depicted in the drawings. For example, if the device in a figure is turned over, then elements described as “below other elements or features” or “under other elements or features” will be oriented as “on the other elements or features” or “above the other elements or features”. Thus, the exemplary term “below” may include orientations of both above and below. The device can be otherwise oriented (rotated by 90 degrees or in other directions), and the spatial relationship descriptors used herein will be explained accordingly.

The present disclosure proposes a cooking apparatus, such as a microwave, an oven, a micro steaming and baking integrated machine, and other cooking apparatuses. For ease of description, this embodiment will be described only using an example in which a microwave oven having the steam heating function is the cooking apparatus.

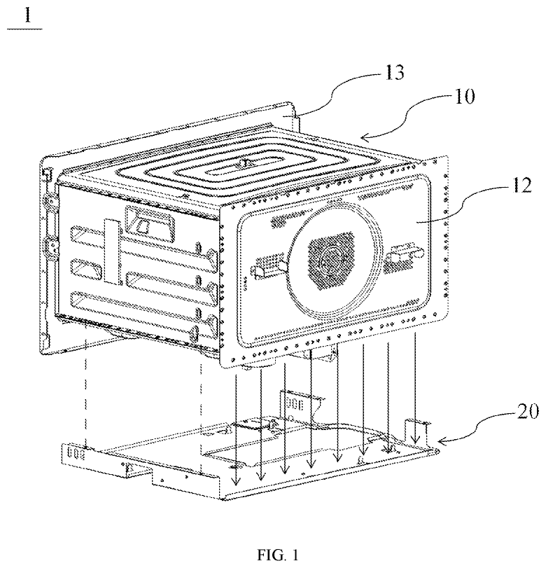

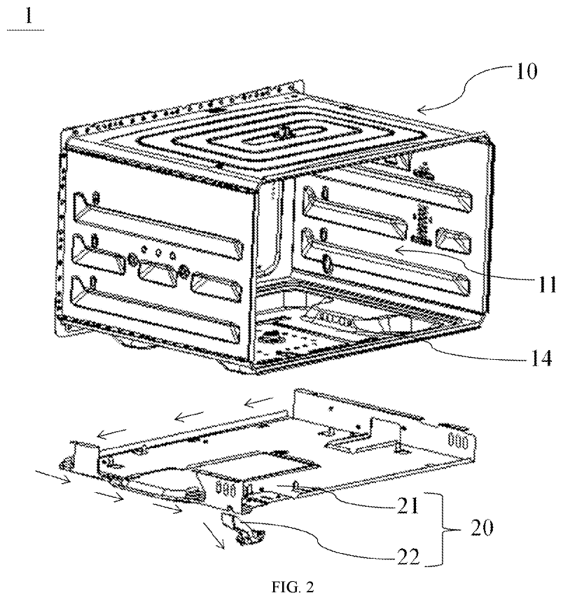

As shown in FIGS. 1 and 2, the cooking apparatus 1 of this embodiment includes a cavity 10 and a shell, and the shell covers the outside of the cavity 10 and is arranged spaced apart from the cavity 10. An interior of the cavity 10 forms a cooking chamber 11 for heating food. One end of the cooking chamber 11 has an opening, and a door is provided at the opening. By operating the door, the cooking chamber 11 can be opened or closed and food can be placed into or taken out from the cooking chamber 11. Specifically, the cavity 10 includes a rear plate 12 and a front plate 13 that are arranged opposite to each other. A bottom plate 14 is arranged between the rear plate 12 and the front plate 13, and the front plate 13 and the rear plate 12 are connected through the bottom plate 14. In the cooking apparatus 1 of this embodiment, a water flow hole (not shown) is provided between the rear plate 12 and the bottom plate 14. The water flow hole may have various forms, such as a strip-shaped hole extending in a length direction of the rear plate 12, or multiple hole-like structures arranged at intervals at the connection between the rear plate 12 and the bottom plate 14. When the cooking apparatus 1 is heating, water vapor will be generated. After the heating process is completed, the water vapor forms condensed water after being cooled, which falls onto the bottom of the cooking chamber 11 and eventually flows out through the water flow hole to the bottom of the cavity 10. A flow guide assembly 20 is provided at the bottom of the cavity 10, and the flow guide assembly 20 is used to receive the condensed water flowing out of the cooking chamber 11 and guide the condensed water to flow to a wastewater box (not shown) at the bottom of the cooking apparatus 1, to achieve collection of the condensed water. In FIG. 1, the direction indicated by the straight arrows is an outflow direction of the condensed water in the cooking chamber 11. In this embodiment, the wastewater box is located directly below the door of the cooking apparatus 1 and is set lower than the flow guide assembly 20, to facilitate the flow and collection of condensed water. In other embodiments of this application, the water flow hole can also be arranged on the bottom plate 14 at a position close to the rear plate 12, or can be arranged on the bottom plate 14 at a position close to the center, and the position of the flow guide assembly 20 at the bottom of the cavity 10 is adjusted correspondingly.

It should be further noted that in this embodiment, when the user faces the cooking apparatus 1, a side of the cooking apparatus 1 that faces the ground is the bottom of the cooking apparatus 1, a side of the cooking apparatus 1 that is away from the ground is the top of the cooking apparatus 1, a side of the cooking apparatus 1 on the left side of the user is the left side of the cooking apparatus 1, a side of the cooking apparatus 1 on the right side of the user is the right side of the cooking apparatus 1, a side of the cooking apparatus 1 that is close to the user is the front side of the cooking apparatus 1, and the side of the cooking apparatus 1 that is away from the user is the rear side of the cooking apparatus 1. Specifically, in this embodiment, the side of the cooking chamber 11 that has the opening is the front side, that is, the side where the door is located is the front side.

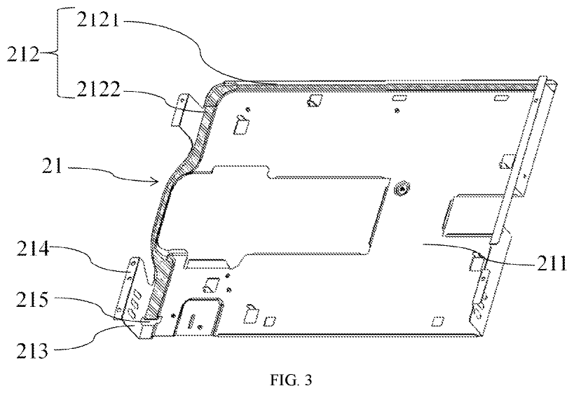

Specifically, as shown in FIGS. 2 to 4, the flow guide assembly 20 of this embodiment includes a support plate 21, which includes a support portion 211 arranged in a plate shape. First flange portions 213 are provided at edges of the support portion 211, and the first flange portions are flanged toward the cavity 10. The first flange portions 213 are further flanged toward two sides to form second flange portions 214. The second flange portions 214 are connected to the bottom plate 14 of the cavity 10 through screws, and the support plate 21 is fixedly connected below the cavity 10. The arrangement of the first flange portions 213 enables a certain spacing to be formed between the support portion 211 and the bottom plate 14, to form an accommodation space. Some electrical components or other components are arranged between the bottom plate 14 and the support portion 211. In this embodiment, the support portion 211, the first flange portions 213 and the second flange portions 214 are of an integrated structure, and are integrally formed through metal bending process.

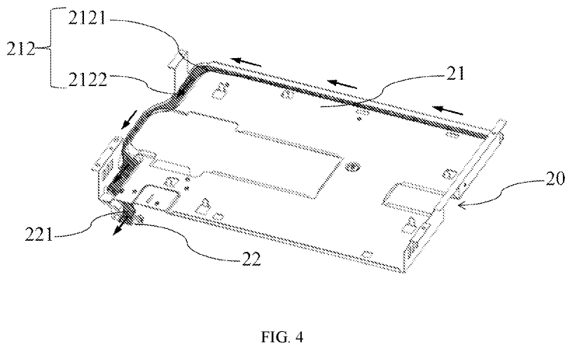

Specifically, as shown in FIGS. 2 to 4, a top face of the support portion 211 of this embodiment is provided with a recessed first flow guide groove 212. The first flow guide groove 212 of this embodiment includes a bottom plate portion and side plate portions located on both sides of the bottom plate portion. The bottom plate portion is arranged inclinedly close to a bottom face of the support plate 21 along its own extension direction. Specifically, the bottom plate portion of this embodiment includes a transverse flow guide portion 2121 and a longitudinal flow guide portion 2122. The transverse flow guide portion 2121 is arranged along a rear-side edge of the support portion 211, and the transverse flow guide portion 2121 extends in a direction from a right-side plate to a left-side plate of the cavity 10 and is arranged inclinedly toward a lower plate face of the support plate 21, and the transverse flow guide portion 2121 forms a first inclined face structure that is arranged inclinedly close to the lower plate face of the support plate 21 from right to left. The longitudinal flow guide portion 2122 is arranged along a left-side edge of the support portion 211, and the longitudinal flow guide portion 2122 extends in a direction from the rear plate 12 to the front plate 13 of the cavity 10 and is arranged inclinedly toward the lower plate face of the support plate 21, and the longitudinal flow guide portion 2122 forms a second inclined face structure that is arranged inclinedly close to the lower plate face of the support plate 21 from rear to front; moreover, at the connection between the transverse flow guide portion 2121 and the longitudinal flow guide portion 2122, a height of the second inclined face structure is lower than or equal to a height of the first inclined face structure, to ensure that the bottom plate portion of the first flow guide groove 212 forms a continuous inclined face structure as a whole, ensuring the flow guide effect on the condensed water, and preventing the condensed water from staying inside the first flow guide groove 212. At the same time, the arrangement of the transverse flow guide portion 2121 in this application has extended a receiving length for receiving the condensed water in the cooking chamber 11, thus facilitating collecting the condensed water in the cooking chamber 11 more effectively and comprehensively. When the condensed water falls into the transverse flow guide portion 2121 through the water flow hole, the condensed water flows from the right side to the left side of the transverse flow guide portion 2121 through the inclined face of the transverse flow guide portion 2121 under the action of gravity. When the condensed water flows to the position where the transverse flow guide portion 2121 contacts the longitudinal flow guide portion 2122, the condensed water flows from rear to front along the inclined face of the longitudinal flow guide portion 2122, and the condensed water is discharged. The direction indicated by the straight arrows in FIGS. 2 and 4 represents the flow direction of condensed water inside the flow guide assembly 20. In other embodiments of the present application, it is also possible to arrange the transverse flow guide portion 2121 only at part of the rear-side edge of the support portion 211, or the arrangement of the transverse flow guide portion 2121 can be canceled, and the longitudinal flow guide portion 2122 can be arranged correspondingly to the water flow hole at the bottom of the cavity 10, to guide the condensed water through the longitudinal flow guide portion 2122.

The first flow guide groove 212 of this embodiment is part of the structure of the support portion 211 and forms an integrated structure with the support portion 211. Specifically, the support portion 211 can be stamped to form a groove structure for guiding the condensed water. Therefore, there are no gaps on the bottom plate portion and the side plate portions of the first flow guide groove 212, and the condensed water can be effectively prevented from leaking during the flow guiding process of the first flow guide groove 212, thus ensuring the normal discharge of condensed water, preventing the condensed water from staying on the support plate 21, reducing damage to other electrical components or sheet metal parts, and improving the safety and reliability of the use of the cooking apparatus 1.

In other examples of this embodiment, the first flow guide groove 212 can also be an independent groove structure, and the bottom plate portion of the first flow guide groove 212 can be detachably or fixedly connected to the top face of the support portion 211. At least the bottom plate portion of the first flow guide groove 212 is of an integrated structure, to prevent the condensed water from leaking during the guiding process. Alternatively, the first flow guide groove 212 can be provided as a tubular structure, and a water inlet end of the tubular structure is communicated with the water flow hole at the bottom of the cavity 10. The tubular structure is arranged as a whole inclinedly in a direction from the rear plate 12 to the front plate 13 of the cavity 10, to guide the condensed water.

Furthermore, as shown in FIGS. 2 to 4, the flow guide assembly 20 of this embodiment further includes a transition portion 22, which is located below the support plate 21. The transition portion 22 is detachably connected to the support plate 21. In other embodiments of this application, the transition portion 22 can also form an integrated structure with the support plate 21. A second flow guide groove 221 is provided on the transition portion 22, and the second flow guide groove 221 is roughly arranged from top to bottom as a whole to guide the condensed water in the first flow guide groove 212 into the wastewater box. The support plate 21 of this embodiment is further provided with a drain hole 215, which is located at an extremity end in the extending direction of the first flow guide groove 212 and penetrates through the support plate 21. A water inlet end of the second flow guide groove 221 is located directly below the drain hole 215. After being guided by the first flow guide groove 212, the condensed water in the cooking chamber 11 enters the second flow guide groove 221 through the drain hole 215, and further enters the wastewater box after being guided by the second flow guide groove 221, and the condensed water is effectively guided and collected.

The second flow guide groove 221 of this embodiment is part of the structure of the transition portion 22 and forms an integrated structure with the transition portion 22.

Specifically, the transition portion 22 can be stamped to form a groove structure for guiding the condensed water. Therefore, there are no gaps inside the second flow guide groove 221, and the condensed water can be effectively prevented from leaking during the flow guiding process of the second flow guide groove 221, thus ensuring the normal discharge of condensed water, preventing the condensed water from leaking during the flow guiding process of the second flow guide groove 221, reducing damage to other electrical components or sheet metal parts, and improving the safety and reliability of the use of the cooking apparatus 1.

In other examples of this embodiment, the second flow guide groove 221 can also be an independent groove structure, and a bottom plate portion of the second flow guide groove 221 can be detachably or fixedly connected to the transition portion 22. At least the bottom plate portion of the second flow guide groove 221 is of an integrated structure, to prevent the condensed water from leaking during the guiding process. Alternatively, the second flow guide groove 221 can be provided as a tubular structure, and a water inlet end of the tubular structure is communicated with the water flow hole at the bottom of the cavity 10, to guide the condensed water.

Further, the cooking apparatus 1 of this embodiment further includes a base, which is arranged below the support plate 21. The base, together with the shell, forms the outermost structure of the cooking apparatus 1 for protection of the cooking apparatus 1. In other embodiments of the present application, the structure of the base can be canceled, and the support plate 21 serves as the base of the cooking apparatus 1.

Further, the cooking apparatus 1 of this embodiment further includes a steam generation assembly, which includes a water box, a steam generator, and a communication pipeline for communicating the water box with the cooking chamber 11. A vapor outlet end of the communication pipeline is arranged on the left-side plate or right-side plate of the cavity 10 and is communicated with the cooking chamber 11. The water box is arranged on the top face or bottom face of the support plate 21 to provide water vapor to the cooking chamber 11. When the steam generation assembly is operating, the water in the water box forms water vapor under the action of the steam generator. The water vapor is transported to the interior of the cooking chamber 11 through the communication pipeline for steam-heating the food inside the cooking chamber 11. However, steam-heating will generate a large amount of water vapor. When cooking is stopped, the water vapor condenses due to cooling and forms condensed water. Therefore, it is necessary to effectively discharge the condensed water in the cooking chamber 11 to improve the working environment of the cooking chamber 11, improve the cooking efficiency, and enhance the user experience.

Described above are only specific embodiments of the present disclosure, but the scope of protection of the present disclosure is not limited to this. Changes or substitutions that can be easily made within the scope disclosed by the present disclosure should be covered within the scope of protection of the present disclosure. Therefore, the scope of protection of the present disclosure shall be accorded with the scope of protection of the claims.

1. A flow guide assembly, comprising:
a support plate; and
a first flow guide groove arranged on the support plate or being part of a structure of the support plate; wherein the first flow guide groove comprises a bottom plate portion and side plate portions arranged on both sides of the bottom plate portion; the bottom plate portion is of an integrated structure, and comprises a transverse flow guide portion and a longitudinal flow guide portion; the transverse flow guide portion is arranged inclinedly toward a lower plate face of the support plate in a length direction of the support plate, the longitudinal flow guide portion is arranged inclinedly toward the lower plate face of the support plate in a width direction of the support plate, and a highest point of the longitudinal flow guide portion is set lower than or equal to a lowest point of the transverse flow guide portion.

2. The flow guide assembly according to claim 1, wherein the bottom plate portion and the side plate portions on both sides are of an integrated structure.

3. The flow guide assembly according to claim 1, wherein the first flow guide groove is a groove formed by a top face of the support plate being recessed toward a bottom face of the support plate.

4. The flow guide assembly according to claim 1, wherein the first flow guide groove is arranged along an outer edge of the support plate.

5. The flow guide assembly according to claim 1, wherein the transverse flow guide portion and the longitudinal flow guide portion are respectively arranged on two adjacent side edges of the support plate.

6. The flow guide assembly according to claim 1, wherein the support plate is further provided with a drain hole, which is located at an extremity end in an extending direction of the first flow guide groove and penetrates through the support plate.

7. The flow guide assembly according to claim 6, further comprising a transition portion which is located below the support plate, wherein the transition portion is provided with a second flow guide groove which is communicated with the drain hole.

8. The flow guide assembly according to claim 7, wherein the transition portion and the support plate are of an integrated structure or a detachable structure.

9. A cooking apparatus comprising:
a flow guide assembly, comprising:
a support plate; and
a first flow guide groove arranged on the support plate or being part of a structure of the support plate; wherein the first flow guide groove comprises a bottom plate portion and side plate portions arranged on both sides of the bottom plate portion; the bottom plate portion is of an integrated structure, and comprises a transverse flow guide portion and a longitudinal flow guide portion; the transverse flow guide portion is arranged inclinedly toward a lower plate face of the support plate in a length direction of the support plate, the longitudinal flow guide portion is arranged inclinedly toward the lower plate face of the support plate in a width direction of the support plate, and a highest point of the longitudinal flow guide portion is set lower than or equal to a lowest point of the transverse flow guide portion,
wherein the cooking apparatus further comprises a cavity with a cooking chamber, the flow guide assembly is arranged below the cavity, a water flow hole is arranged at the bottom of the cavity, and the first flow guide groove is arranged opposite to the water flow hole.

10. The cooking apparatus according to claim 9, wherein the bottom plate portion is arranged inclinedly toward a bottom face of the support plate in a direction from a back plate to a front plate of the cavity.

11. The cooking apparatus according to claim 9, wherein the bottom plate portion and the side plate portions on both sides are of an integrated structure.

12. The cooking apparatus according to claim 9, wherein the first flow guide groove is a groove formed by a top face of the support plate being recessed toward a bottom face of the support plate.

13. The cooking apparatus according to claim 9, wherein the first flow guide groove is arranged along an outer edge of the support plate.

14. The cooking apparatus according to claim 9, wherein the transverse flow guide portion and the longitudinal flow guide portion are respectively arranged on two adjacent side edges of the support plate.

15. The cooking apparatus according to claim 9, wherein the support plate is further provided with a drain hole, which is located at an extremity end in an extending direction of the first flow guide groove and penetrates through the support plate.

16. The cooking apparatus according to claim 15, further comprising a transition portion which is located below the support plate, wherein the transition portion is provided with a second flow guide groove which is communicated with the drain hole.

17. The cooking apparatus according to claim 16, wherein the transition portion and the support plate are of an integrated structure or a detachable structure.

18. The flow guide assembly according to claim 1, wherein the bottom plate portion is arranged inclinedly toward a bottom face of the support plate in a direction from a back plate to a front plate of a cavity.
